(19) United States
(12) Patent Application Publication
(10) Pub. No.: US 2012/0064751 A1
(43) Pub. Date: Mar. 15, 2012

(54) Electrical Connector Assembly

(76) Inventor: Xiao Zhou, Shanghai (CN)

(21) Appl. No.: 13/233,425

(22) Filed: Sep. 15, 2011

(30) Foreign Application Priority Data
Sep. 15, 2010 (CN) 201020537429.1

(51) Int. Cl. H01R 13/62

(52) U.S. Cl. 439/345

(57) ABSTRACT

An electrical connector assembly includes a plug and a receptacle. The plug includes a first contact for a high voltage circuit and a second contact for a low voltage circuit. The receptacle includes a first mating contact for the high voltage circuit and a second mating contact for the low voltage circuit. Either the plug or the receptacle is provided with a first locking mechanism and a second locking mechanism spaced at a predetermined distance apart in a direction of inserting the plug into the receptacle, while the other of the plug and the receptacle includes a catching mechanism securable with the first and the second locking mechanisms respectively.

### CROSS-REFERENCE TO RELATED APPLICATION

This application claims the benefit of the filing date under 35 U.S.C. §119(a)-(d) of Chinese Patent Application No. 201020537429.1 filed on Sep. 15, 2010 in China.

### FIELD OF INVENTION

The present invention relates generally to an electrical connector assembly, and particularly to an electrical connector assembly to switch on/switch off a high voltage circuit and a low voltage circuit.

### BACKGROUND

In the prior art, for the purpose of safety, a high voltage circuit and a low voltage circuit are often physically independent and separate from each other. Accordingly, it is necessary to provide a separate high voltage connector assembly to switch on/switch off the high voltage circuit, and a separate low voltage connector assembly to switch on/switch off the low voltage circuit.

Furthermore, when switching off the high voltage circuit and the low voltage circuit, the operation is typically carried out in two stages: the connector for the low voltage circuit is switched off firstly, and after a predetermined time interval from switching off the low voltage circuit, the connector for the high voltage circuit is switched off. That is, the operation of switching off the high voltage circuit and the low voltage circuit is performed in two steps and at a predetermined time interval.

In the prior art configuration, because two separate connector assemblies are used to operate the high and low voltage circuits, the cost of manufacturing the connector assemblies increased and the operation of the connector assemblies becomes more difficult.

### SUMMARY

The present invention has been achieved to overcome or alleviate at least one aspect of the above mentioned disadvantages, among others.

The embodiments described herein relate to an electrical connector assembly, which is a single unit operable in two stages to switch on/switch off a high voltage circuit and a low voltage circuit. The present invention employs a single electrical connector assembly to switch on/switch off the high voltage circuit and the low voltage circuit, instead of using two separate electrical connector assemblies. The invention, therefore, can simplify the structure of the connector assembly, save cost and make the operation of the connector easier.

The electrical connector assembly according to the invention includes a plug and a receptacle. The plug includes a first contact for a high voltage circuit and a second contact for a low voltage circuit. The receptacle includes a first mating contact for the high voltage circuit and a second mating contact for the low voltage circuit. Either the plug or the receptacle is provided with a first locking mechanism and a second locking mechanism spaced at a predetermined distance apart in a direction of inserting the plug into the receptacle, while the other of the plug and the receptacle includes a catching mechanism securable with the first and the second locking mechanisms respectively.

### BRIEF DESCRIPTION OF THE DRAWINGS

The above and other features of the present invention will become more apparent by describing in detail exemplary embodiments thereof with reference to the accompanying drawings, in which:

FIG. 1 is a perspective view of an electrical connector assembly according to the invention;

FIG. 2 is a perspective view of another electrical connector assembly according to the invention;

FIG. 3 is a cross sectional view of the electrical connector assembly of FIG. 2, wherein a plug is moved to a first locking position;

FIG. 4 is another cross sectional view of the electrical connector assembly of FIG. 2, wherein the plug is moved to a second locking position;

FIG. 5 is a schematic view showing that contacts of a high voltage circuit and a low voltage circuit are engaged when the plug is moved to the first locking position;

FIG. 6 is a schematic view showing that the contacts of the high voltage circuit are engaged and the contacts of the low voltage circuit are disengaged when the plug is moved to a second locking position; and

FIG. 7 is a schematic view showing that the contacts of the high voltage circuit and the low voltage circuit are disengaged when the plug is moved to a separate position.

### DETAILED DESCRIPTION OF THE EMBODIMENT(S)

Exemplary embodiments of the invention will be described hereinafter in detail with reference to the attached drawings, wherein the like reference numerals refer to the like elements. The invention may, however, be embodied in many different forms and should not be construed as being limited to a particular embodiment set forth herein; rather, these disclosed embodiments are provided so that the present disclosure will be thorough and complete, and will fully convey the concept of the disclosure to those skilled in the art.

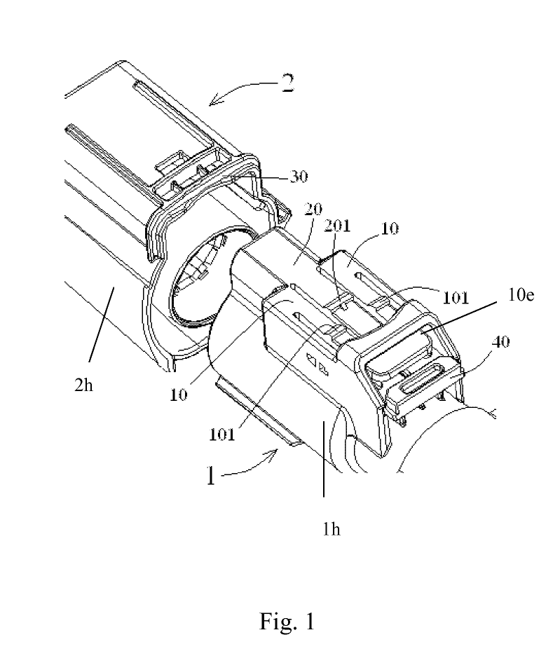

As shown in FIG. 1, the electrical connector assembly according to the invention includes a plug 1 and a receptacle 2. More specifically, the plug 1 includes a pair of first elastic arms 10 on a plug housing 1h. Each of the elastic arms 10 has a first locking protuberance 101 thereon. In this shown embodiment, the first elastic arms 10 having the first locking protuberances 101 are served as a first locking mechanism. The pair of first elastic arms 10 have respective free ends 10e, which are joined to each other.

As FIG. 1 shows, the plug 1 is further formed with a second elastic arm 20 on the plug housing 1h. The second elastic arm 20 has a second locking protuberance 201 thereon. In one example, the second elastic arm 20 having the second locking protuberance 201 is served as a second locking mechanism. The second elastic arm 20 is positioned in a arm receiving passageway between the pair of first elastic arms 10 and is formed like a tongue member.

As shown in FIG. 1, the receptacle 2 includes a catch 30 on the receptacle housing 2h. In this exemplary embodiment, the catch 30 serves as a catching mechanism. The catch 30 engages with the first locking protuberance 101 and the second locking protuberance 201 respectively.

Furthermore, the first locking protuberance 101 is positioned behind the second locking protuberance 201 and is spaced from the second locking protuberance 201 with a predetermined distance in a direction of inserting the plug 1 into the receptacle 2. In this way, during insertion of the plug 1 into the receptacle 2, the second locking protuberance 201 firstly engages with the catch 30, and after a predetermined time interval, the first locking protuberance 101 engages with the catch 30. When pulling the plug 1 out of the receptacle 2, the first locking protuberance 101 is firstly disengaged with the catch 30, and after a predetermined time interval, the second locking protuberance 201 is disengaged with the catch 30.

In shown embodiment, the location where the first locking protuberance 101 is engaged with the catch 30 is referred as a first locking position, and the location where the second locking protuberance 201 is engaged with the catch 30 is referred as a second locking position. The location where the first and second locking protuberances 101, 201 both are disengaged with the catch 30 is referred as a separation position.

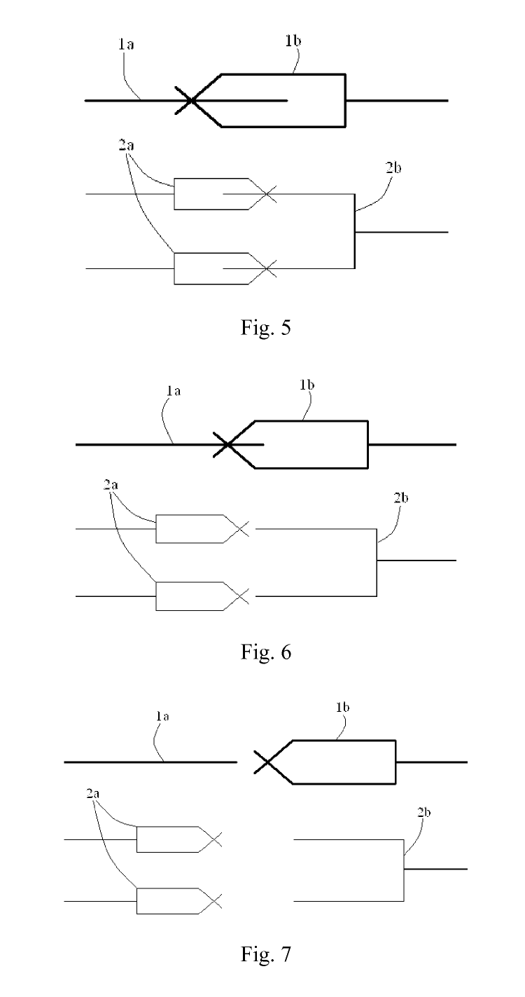

As shown in FIGS. 5-7, the plug 1 has a first contact la for the high voltage circuit and a second contact 2a for the low voltage circuit. The receptacle 2 has a first mating contact 1b for the high voltage circuit and a second mating contact 2b for the low voltage circuit.

As shown in FIG. 1 and FIG. 5, when the plug 1 is moved relative to the receptacle 2 into the first locking position, the first contact 1a of the high voltage circuit is electrically connected with the first mating contact 1b of the high voltage circuit to switch on the high voltage circuit, while the second contact 2a of the low voltage circuit is electrically connected with the second mating contact 2b of the low voltage circuit to switch on the low voltage circuit. That is, when the plug 1 is moved relative to the receptacle 2 into the first locking position, the high voltage circuit and the low voltage circuit both are switched on.

As shown in FIG. 1 and FIG. 6, after the plug 1 is pulled from the first locking position out of the receptacle 2, the plug 1 is moved to the second locking position after a predetermined period of time. At the second locking position, the first contact 1a of the high voltage circuit is electrically connected with the first mating contact 1b of the high voltage circuit to switch on the high voltage circuit, while the second contact 2a of the low voltage circuit is disconnected with the second mating contact 2b of the low voltage circuit to switch off the low voltage circuit. That is, when the plug 1 is moved relative to the receptacle 2 from the first locking position to the second locking position, the high voltage circuit is switched on and both of the low voltage circuits are switched off

As shown in FIG. 1 and FIG. 7, as the plug 1 is continuously pulled out of the receptacle 2, the plug 1 and the receptacle 2 reach the separation position after a predetermined period of time. At the separation position, the first contact 1a of the high voltage circuit is disconnected with the first mating contact 1b of the high voltage circuit to switch off the high voltage circuit, and the second contact 2a of the low voltage circuit is disconnected with the second mating contact 2b of the low voltage circuit to switch off the low voltage circuit. That is, when the plug 1 is continuously moved relative to the receptacle 2 into the separation position, as shown in FIG. 7, the high voltage circuit and the low voltage circuits are switched off.

Accordingly, the process of pulling the plug 1 out of the receptacle 2 is performed in two steps with a predetermined time interval. In the first step, the plug 1 is moved from the first locking position to the second locking position, as shown in FIGS. 5-6, so that the low voltage circuit is switched from “ON” state to “OFF” state, and the high voltage circuit keeps “ON” state. In the second step, the plug 1 is moved from the second locking position to the separation position, as shown in FIGS. 6-7, so that the low voltage circuit stays in the “OFF” state, and the high voltage circuit is switched from the “ON” state to the “OFF” state.

The process of inserting the plug 1 into the receptacle 2 is also performed in two steps with a predetermined time interval. In the first step, the plug 1 is moved from the separation position to the second locking position, as shown in FIGS. 6-7, so that the high voltage circuit is switched from the “OFF” state to the “ON” state, while the low voltage circuit keeps the “OFF” state. In the second step, the plug 1 is moved from the second locking position to the first locking position, as shown in FIGS. 5-6, so that the high voltage circuit keeps the “OFF” state, while the low voltage circuit is switched from the “OFF” state to the “ON” state.

As is shown in FIG. 1, the electrical connector assembly can further include a stopper 40. The stopper 40 is configured to be inserted into a stopper receiving passageway under the first and second elastic arms 10, 20 to prevent the elastic deformation of the first and second elastic arms 10, 20. In addition, the stopper 40 is configured to be pulled out of the space under the first and second elastic arms 10, 20 to allow the elastic deformation of the first and second elastic arms 10, 20.

For example, when the plug 1 is moved relative to the receptacle 2 into the first locking position, the stopper 40 can be inserted into the space under the first and second elastic arms 10, 20 to occupy the space under the first and second elastic arms 10, 20 so that the first and second elastic arms 10, 20 cannot be deformed toward the space under them. In this way, the first and second elastic arms 10, 20 can be secured in the locked state, and the high and the low voltage circuits may be secured in the “ON” state as shown in FIG. 5.

As is shown in FIG. 1, the plug 1 can further include a guard 50. In one example, the guard 50 is configured and positioned to protect the second elastic arm 20 on the plug 1 from being accessed when the plug 1 is in the first locking position. For example, the guard 50 can be positioned to block access to the second elastic arm 20, when the plug 1 is at its first locking position. For example, after the plug 1 is inserted into the receptacle 2, the guard 50 can cover at least part of the second elastic arm 20 exposed outside the receptacle 2. As a result, the guard 50 can prevent the second elastic arm 20 from being accidentally pressed down to release the lock between the second locking protuberance 201 on the second elastic arm 20 and the catch 30 on the receptacle 2.

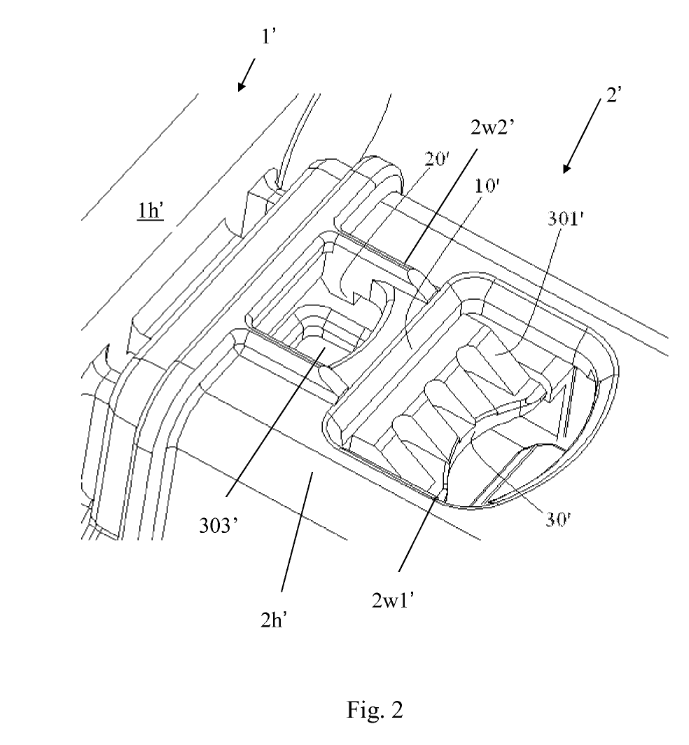

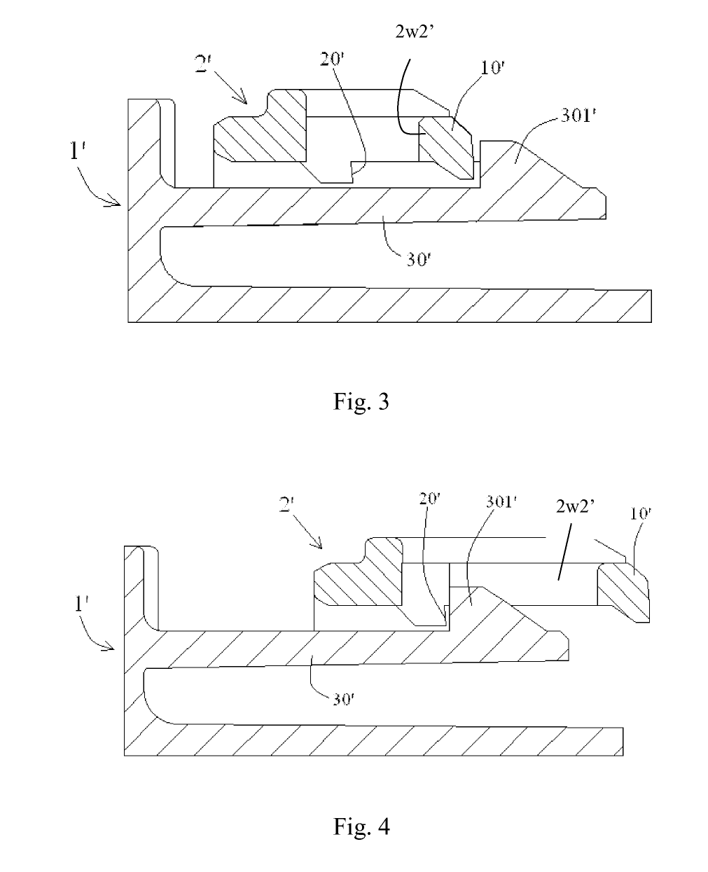

As shown in FIGS. 2-4, the receptacle 2′ includes a first lock 10′ and a second lock 20′ on the receptacle housing 2h′. In the shown embodiment, the first lock 10′ is served as a first locking mechanism, and the second lock 20′ is served as a second locking mechanism. As shown in FIGS. 3-4, the first lock 10′ and the second lock 20′ are spaced at a predetermined distance in a direction of inserting the plug 1′ into the receptacle 2′.

Referring to FIGS. 2-4, the plug 1′ includes an elastic arm 30′. The elastic arm 30′ has a catch 301′ for engaging with respectively the first lock 10′ and the second lock 20′ on the receptacle housing 2h′. In the shown embodiment, the elastic arm 30′ having the catch 301′ is the catching mechanism.

As shown in FIG. 3, the catch 301′ engages with the first lock 10′, that is, the plug 1′ is positioned at a first locking position relative to the receptacle 2′. At this time, please refer to FIG. 5, the high and low voltage circuits are both switched on.

As shown in FIG. 4, the catch 301′ engages with the second lock 20′, that is, the plug 1′ is positioned at a second locking position relative to the receptacle 2′. At this time, please refer to FIG. 6, the high voltage circuit is kept in the “ON” state, and the low voltage circuit is switched off.

As the first and second locks 10′, 20′ on the receptacle housing 2h′ are spaced at a predetermined distance in the insertion direction of the plug 1′, it takes time for the catch 301′ of the plug 1′ to move from the first lock 10′ to the second lock 20′ on the receptacle housing 2h′, when pulling the plug 1′ and the receptacle 2′ apart from each other.

In the embodiment shown of FIG. 2, the receptacle 2′ includes a first locking protuberance passageway 2w1′ in the receptacle housing 2h′ to expose the catch 301′ of the plug 1′, when the plug 1′ is positioned at the first locking position. The first locking protuberance passageway 2w1′ in the receptacle housing 2h′ allows an operator to access the catch 301′ of the plug 1′ during operation. For example, when the plug 1′ is at the first locking position as shown in FIG. 3, the operator can press the catch 301′ of the plug 1′ through such first locking protuberance passageway 2w1′ in the receptacle housing 2h′, to thereby release the catch 301′ from locking with the first lock 10′ on the receptacle 2′. The plug 1′ can then be moved from the first locking position into the second locking position, where the catch 301′ of the plug 1′ engages with the second lock 20′ on the receptacle 2′, as is best shown in FIG. 4.

In addition, the receptacle 2′ includes a second locking protuberance passageway 2w2′ in the receptacle housing 2h′ to expose the catch 301′ of the plug 1′, when the plug 1′ is positioned at the second locking position, as is shown in FIG. 4. The second locking protuberance passageway 2w2′ in the receptacle housing 2h′ allows an operator to access the catch 301′ of the plug 1′ during operation. For example, when the plug 1′ is at the second locking position shown in FIG. 4, the operator can press the catch 301′ of the plug 1′ through such second locking protuberance passageway 2w2′, to thereby release the catch 301′ from locking with the second lock 10′ of the receptacle 2′. The plug 1′ can then move from the second locking position into the separation position, to thereby separate the plug 1′ from the receptacle 2′.

In the exemplary embodiment shown in FIG. 2, the elastic arm 30′ on the plug 1′ includes an aperture 303′. The aperture 303′ is so positioned on the plug 1′ that the aperture 303′ is aligned with the second locking protuberance passageway 2w2′ in the receptacle housing 2h′ when the plug 1′ is at the first locking position. Such aperture 303′ can function as a safety measure to the electrical connector assembly. More specifically, when the plug 1′ is at the first locking position shown in FIGS. 2 and 3, the aperture 303′ in the elastic arm 30′ can prevent the elastic arm 30′ from being pressed down through the second locking protuberance passageway 2w2′ in the receptacle housing 2h′. As a result, the catch 301′ of the plug 1′ will not be accidentally released from the second lock 10′ of the receptacle 2′, when the plug 1′ of the electrical connector assembly is at the first locking position.

Although it is not illustrated, the electrical connector assembly according to the second exemplary embodiment can also include a stopper. Such a stopper can be configured to be inserted into a space under the elastic arm 30′ to prevent the elastic deformation of the elastic arm 30′ and configured to be pulled out of the space under the elastic arm 30′ to allow the elastic deformation of the elastic arm 30′.

Please be noted that the operation process of the electrical connector assembly shown in FIGS. 2-4 is similar to the electrical connector assembly shown in FIG. 1. Therefore, the operation process of the electrical connector assembly shown in FIGS. 2-4 is omitted herein.

It should be understood for those skilled in this art that the present invention is not limited to the exemplary embodiments shown in FIGS. 1-7. For example, in the first exemplary embodiment, the first and second elastic arms 10, 20 are formed on the plug 1, and the catch 30 is formed on the receptacle 2. But, the present invention is not limited to this configuration. For example, the first and second elastic arms 10, 20 can be formed on the receptacle 2, while the catch 30 can be formed on the plug 1.

In addition, in the first exemplary embodiment, the plug 1 includes two elastic arms 10, 20 each having a locking protuberance 101, 201 thereon. But, the present invention is not limited to this configuration. For example, the plug 1 can be formed with only one elastic arm having two protuberances spaced at a predetermined distance in the direction of inserting the plug 1 into the receptacle 2.

Further, in the second exemplary embodiment, the first and second locks 10′, 20′ are formed on the receptacle 2′, and the elastic arm 30′ is formed on the plug 1′. But, the present invention is not limited to this configuration. For example, the first and second locks 10′, 20′ can be formed on the plug 1′, and the elastic arm 30′ can be formed on the receptacle 2′.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An electrical connector assembly comprising:
a plug having a first contact for a high voltage circuit and a second contact for a low voltage circuit; and
a receptacle having a first mating contact for the high voltage circuit and a second mating contact for the low voltage circuit;
wherein one of the plug and the receptacle is provided with a first locking mechanism and a second locking mechanism spaced at a predetermined distance apart in a direction of inserting the plug into the receptacle, and another one of the plug and the receptacle includes a catching mechanism securable with the first and the second locking mechanisms respectively;
wherein the first contact electrically connects with the first mating contact to switch on the high voltage circuit and the second contact is electrically connected with the second mating contact to switch on the low voltage circuit when the plug is moved relative to the receptacle into a first locking position where the first locking mechanism secures with to the catching mechanism;
wherein the first contact electrically connects with the first mating contact to switch on the high voltage circuit and the second contact disconnects with the second mating contact to switch off the low voltage circuit when the plug is moved relative to the receptacle into a second locking position where the second locking mechanism is secureds with the catching mechanism;
wherein the first contact disconnects from the first mating contact to switch off the high voltage circuit and the second contact disconnects from the second mating contact to switch off the low voltage circuit when the plug is moved relative to the receptacle into a separation position where the first and second locking mechanisms are both separated from the catching mechanism.

2. The electrical connector assembly according to claim 1, wherein the first locking mechanism includes a first elastic arm positioned on one of the plug and the receptacle and has a first locking protuberance positioned thereon.

3. The electrical connector assembly according to claim 2, wherein the second locking mechanism includes a second elastic arm positioned on the one of the plug and the receptacle and has a second locking protuberance positioned thereon.

4. The electrical connector assembly according to claim 3, wherein the catching mechanism is a catch positioned on the other of the plug and the receptacle being engagable with the first and second protuberances respectively.

5. The electrical connector assembly according to claim 4, wherein the first locking protuberance and the second locking protuberance are spaced at the predetermined distance apart.

6. The electrical connector assembly according to claim 5, wherein the first locking mechanism is a pair of first elastic arms positioned on the plug.

7. The electrical connector assembly according to claim 6, wherein the second elastic arm is positioned in an arm receiving passageway between the pair of first elastic arms.

8. The electrical connector assembly according to claim 7, wherein the plug includes a guard preventing access to the second elastic arm on the plug when the plug is in the first locking position.

9. The electrical connector assembly according to claim 8, wherein the free ends of the pair of first elastic arms extend beyond the guard and are exposed for access when the plug is at the first locking position.

10. The electrical connector assembly according to claim 4, wherein the plug includes a guard preventing access to the second elastic arm on the plug when the plug is in the first locking position.

11. The electrical connector assembly according to claim 4, further comprising a stopper insertable into a stopper receiving passageway positioned under the first and second elastic arms preventing an elastic deformation of the first and second elastic arms.

12. The electrical connector assembly according to claim 1, wherein the first locking mechanism is a first lock formed on one of the plug and the receptacle.

13. The electrical connector assembly according to claim 12, wherein the second locking mechanism is a second lock formed on the one of the plug and the receptacle.

14. The electrical connector assembly according to claim 13, wherein the catching mechanism is configured to be an elastic arm formed on the other of the plug and the receptacle.

15. The electrical connector assembly according to claim 14, wherein the elastic arm includes a catch engagable with the first lock and the second lock respectively.

16. The electrical connector assembly according to claim 15, wherein the first lock and the second lock are positioned at the predetermined distance apart from each other.

17. The electrical connector assembly according to claim 16, wherein the receptacle includes a housing at least partially surrounding the plug, the housing having first and second locking protuberance passageways.

18. The electrical connector assembly according to claim 17, wherein the elastic arm includes an aperture aligning with the second locking protuberance passageway on the housing when the plug is at the first locking position.

19. The electrical connector assembly according to claim 15, wherein the elastic arm on the receptacle includes a locking protuberance engagable with the first and second locks in the first and second locking positions.

20. The electrical connector assembly according to claim 15, further comprising a stopper insertable into a stopper receiving passageway positioned under the elastic arm to prevent an elastic deformation of the elastic arm and is configured to be pulled out of the stopper receiving passageway.
